(19) United States
(12) Patent Application Publication
(10) Pub. No.: US 2019/0020643 A1
(43) Pub. Date: Jan. 17, 2019

(54) SECURING AN INTERFACE AND A PROCESS FOR ESTABLISHING A SECURE COMMUNICATION LINK

(71) Applicant: Gustavo TANONI, St-Lambert (CA)

(72) Inventor: Gustavo TANONI, St-Lambert (CA)

(73) Assignee: TELEFONAKTIEBOLAGET LM ERICSSON (PUBL), Stockholm (SE)

(21) Appl. No.: 16/070,080

(22) PCT Filed: Feb. 12, 2016
(86) PCT No.: PCT/IB2016/050770

§ 371 Date: Jul. 13, 2018

(51) Int. Cl. H04L 29/06; G06F 21/57; H04L 9/32

(52) U.S. Cl. CPC H04L 63/083; G06F 2221/034; H04L 9/3273; G06F 21/575

(57) ABSTRACT

The disclosure relates to methods and physical and virtual nodes for securing an interface and for securing a process for establishing a secure communication link between an Application Function located in an unsecure zone and an Authentication Function. In one embodiment, the method comprises the Application Function sending an authentication request message to the Authentication Function, receiving a response to the authentication request from the Authentication Function including an authentication challenge and sending a challenge response to the Authentication Function. The method comprises, upon receiving a response indicating success from the Authentication Function, the Application Function generating a session key using secret authentication credentials and information included in the authentication challenge and the Application Function handshaking with the Authentication Function and establishing the secure communication link using the session key, thereby securing the interface between the Application Function and the Authentication Function.

### TECHNICAL FIELD

The present disclosure relates to securing an interface and a process for establishing a secure communication link between network entities.

### BACKGROUND

General Bootstrapping Architecture (GBA) is standardized and described in document 3GPP TS 33.220 V12.3.0 (2014-06) entitled “3rd Generation Partnership Project; Technical Specification Group Services and System Aspects; Generic Authentication Architecture (GAA); Generic Bootstrapping Architecture (GBA)”.

FIG. 1 illustrates the basic elements of GBA, which is a technology that enables authentication of a user.

The User Equipment (UE) 10 is connected to the Bootstrapping Server Function (B SF) 20 through the Ub interface. The UE is also connected to the Network Application Function (NAF) through the Ua interface. The NAF 30 is connected to the BSF 20 through the Zn interface 50. Finally, the BSF 20 is connected to the Home Subscriber Server (HSS) 40 through the Zh interface. The above mentioned standard document explains in more details the bootstrapping (which is another name for an authentication procedure) architecture and requirements on each interface Ub, Ua, Zh and Zn (which are called reference points in the standard document).

Historically, the Network Application Function (NAF) and the Bootstrapping Server Function (B SF) were both located in a secure zone, also called militarized zone, of, for example, an operator's network and could communicate without major security issues over the Zn interface. The NAF and BSF were securing the Zn interface using asymmetric encryption through the installation and use of certificates, i.e. private and public keys in the NAF and the BSF, respectively.

Nowadays, however, with the advent of the Internet of Things (IoT), the NAF is pulled out of the secure zone and brought into an enterprise network, for example, thus exposing the Zn interface to an untrusted network.

The solution illustrated in FIG. 2, has been proposed which use a Zn-Proxy 60 to communicate with the BSF 20 through an untrusted network. This solution, however, adds a node to the visited network and cannot be easily scaled.

### SUMMARY

There is therefore a need for another type of solution.

There is provided a method for securing an interface and for securing a process for establishing a secure communication link between an Application Function and an Authentication Function. The method comprises the Application Function located in an unsecure zone sending an authentication request message to the

Authentication Function and the Application Function receiving a response to the authentication request from the Authentication Function including an authentication challenge. The method comprises the Application Function sending a challenge response to the Authentication Function and upon receiving a response indicating success from the Authentication Function, the Application Function generating a session key using secret authentication credentials and information included in the authentication challenge. The method comprises the Application Function handshaking with the Authentication Function and establishing the secure communication link using the session key, thereby securing the interface between the Application Function and the Authentication Function.

There is provided a method for securing an interface and for securing a process for establishing a secure communication link between an Application Function located in an unsecure zone and an Authentication Function. The method comprises the Authentication Function receiving an authentication request message from the Application Function and the Authentication Function sending a request for an authentication vector to a Home Subscriber Server (HSS) for an identifier provided in the authentication request message. The method comprises the Authentication Function receiving a response from the HSS including the authentication vector and the Authentication Function sending a response to the authentication request to the Application Function including an authentication challenge derived from the authentication vector. The method comprises the Authentication Function receiving a challenge response from the Application Function and upon validating the challenge response, the Authentication Function generating a session key using information included in the authentication vector. The method comprises the Authentication Function sending a response indicating success to the Application Function and the Authentication Function handshaking with the Application Function and establishing the secure communication link using the session key, thereby securing the interface between the Application Function and the Authentication Function.

There is provided an Application Function node located in an unsecure zone for securing an interface and a process for establishing a secure communication link towards an Authentication Function, the Application Function node comprising a processing circuit and a memory. The memory contains instructions executable by said processing circuit whereby the Application Function node is operative to send an authentication request message to the Authentication Function and receive a response to the authentication request from the Authentication Function including an authentication challenge. The Application Function node is operative to send a challenge response to the Authentication Function and upon receiving a response indicating success from the Authentication Function, generate a session key using secret authentication credentials and information included in the authentication challenge. The Application Function node is operative to handshake with the Authentication Function and establish the secure communication link using the session key, thereby securing the interface between the Application Function and the

Authentication Function.

There is provided an Authentication Function node for securing an interface and a process for establishing a secure communication link towards an Application Function located in an unsecure zone, the Authentication function node comprising a processing circuit and a memory. The memory contains instructions executable by the processing circuit whereby the Authentication Function node is operative to receive an authentication request message from the Application Function and send a request for an authentication vector to a Home Subscriber Server (HSS) for an identifier provided in the authentication request message. The Authentication Function node is operative to receive a response from the HSS including the authentication vector and send a response to the authentication request to the Application Function including an authentication challenge derived from the authentication vector. The Authentication Function node is operative to receive a challenge response from the Application Function and upon validating the challenge response, generate a session key using information included in the authentication vector. The Authentication Function node is operative to send a response indicating success to the Application Function and handshake with the Application Function and establish the secure communication link using the session key, thereby securing the interface between the Application Function and the Authentication Function.

There is provided an Application Function node located in an unsecure zone for securing an interface and a process for establishing a secure communication link towards an Authentication Function. The Application Function node comprises a sending module for sending an authentication request message to the Authentication Function and a receiving module for receiving a response to the authentication request from the Authentication Function including an authentication challenge. The sending module is further for sending a challenge response to the Authentication Function. The receiving module is further for receiving a response indicating success from the

Authentication Function. The Application function node comprises a processing module for generating a session key using secret authentication credentials and information included in the authentication challenge, upon receiving the response indicating success and a communication module for handshaking with the Authentication Function and establishing the secure communication link using the session key, thereby securing the interface between the Application Function and the Authentication Function.

There is provided an Authentication Function node for securing an interface and a process for establishing a secure communication link towards an Application

Function located in an unsecure zone. The Authentication Function node comprises a receiving module for receiving an authentication request message from the Application Function and a sending module for sending a request for an authentication vector to a Home Subscriber Server (HSS) for an identifier provided in the authentication request message. The receiving module is further for receiving a response from the HSS including the authentication vector. The sending module is further for sending a response to the authentication request to the Application Function including an authentication challenge derived from the authentication vector. The receiving module is further for receiving a challenge response from the Application Function. The Authentication Function node comprises a processing module for generating a session key using information included in the authentication vector, upon validating the challenge response. The sending module is further for sending a response indicating success to the Application Function. The Authentication Function node comprises a communication module for handshaking with the Application Function and establishing the secure communication link using the session key, thereby securing the interface between the Application Function and the Authentication Function.

There is provided a non-transitory computer media having stored thereon instructions for securing an interface and for securing a process for establishing a secure communication link between an Application Function located in an unsecure zone and an Authentication Function. The instructions comprise the Application Function sending an authentication request message to the Authentication Function and the Application Function receiving a response to the authentication request from the Authentication Function including an authentication challenge. The instructions comprise the Application Function sending a challenge response to the Authentication Function and upon receiving a response indicating success from the Authentication Function, the Application Function generating a session key using secret authentication credentials and information included in the authentication challenge. The instructions comprise the Application Function handshaking with the Authentication Function and establishing the secure communication link using the session key, thereby securing the interface between the Application Function and the Authentication Function.

There is provided a non-transitory computer media having stored thereon instructions for securing an interface and for securing a process for establishing a secure communication link between an Application Function located in an unsecure zone and an Authentication Function. The instructions comprise the Authentication

Function receiving an authentication request message from the Application Function and the Authentication Function sending a request for an authentication vector to a Home Subscriber Server (HSS) for an identifier provided in the authentication request message. The instructions comprise the Authentication Function receiving a response from the HSS including the authentication vector and the Authentication Function sending a response to the authentication request to the Application Function including an authentication challenge derived from the authentication vector. The instructions comprise the Authentication Function receiving a challenge response from the Application Function and upon validating the challenge response, the Authentication Function generating a session key using information included in the authentication vector. The instructions comprise the Authentication Function sending a response indicating success to the Application Function and the Authentication Function handshaking with the Application Function and establishing the secure communication link using the session key, thereby securing the interface between the Application Function and the Authentication Function.

There is provided an Application Function instance located in an unsecure zone, in a cloud computing environment which provides processing circuit and memory for running the Application Function instance, the memory containing instructions executable by the processing circuit whereby the Application Function instance is operative to send an authentication request message to the Authentication Function and receive a response to the authentication request from the Authentication Function including an authentication challenge. The Application Function instance is operative to send a challenge response to the Authentication Function and upon receiving a response indicating success from the Authentication Function, generate a session key using secret authentication credentials and information included in the authentication challenge. The Application Function instance is operative to handshake with the Authentication Function and establish the secure communication link using the session key, thereby securing the interface between the Application Function and the Authentication Function.

There is provided an Authentication Function instance, in a cloud computing environment which provides processing circuit and memory for running the Authentication Function instance, the memory containing instructions executable by the processing circuit whereby the Authentication Function instance is operative to receive an authentication request message from an Application Function located in an unsecure zone and send a request for an authentication vector to a Home Subscriber Server (HSS) for an identifier provided in the authentication request message. The Authentication Function instance is operative to receive a response from the HSS including the authentication vector and send a response to the authentication request to the Application Function including an authentication challenge derived from the authentication vector. The Authentication Function instance is operative to receive a challenge response from the Application Function and upon validating the challenge response, generate a session key using information included in the authentication vector. The Authentication Function instance is operative to send a response indicating success to the Application Function and handshake with the Application Function and establish the secure communication link using the session key, thereby securing the interface between the Application Function and the Authentication Function.

There is provided a method comprising the step of initiating an instantiation of an Application Function located in an unsecure zone in a cloud computing environment which provides processing circuit and memory for running the Application Function. The Application function, when instantiated, is operative to send an authentication request message to the Authentication Function and receive a response to the authentication request from the Authentication Function including an authentication challenge. The Application function, when instantiated, is operative to send a challenge response to the Authentication Function and upon receiving a response indicating success from the Authentication Function, generate a session key using secret authentication credentials and information included in the authentication challenge. The Application function, when instantiated, is operative to handshake with the Authentication Function and establish the secure communication link using the session key, thereby securing the interface between the Application Function and the Authentication Function.

There is provided a method comprising the step of initiating an instantiation of an Authentication Function in a cloud computing environment which provides processing circuit and memory for running the Authentication Function. The Authentication function, when instantiated, is operative to receive an authentication request message from an Application Function located in an unsecure zone and send a request for an authentication vector to a Home Subscriber Server (HSS) for an identifier provided in the authentication request message. The Authentication function, when instantiated, is operative to receive a response from the HSS including the authentication vector and send a response to the authentication request to the Application Function including an authentication challenge derived from the authentication vector. The Authentication function, when instantiated, is operative to receive a challenge response from the Application Function and upon validating the challenge response, generate a session key using information included in the authentication vector. The Authentication function, when instantiated, is operative to send a response indicating success to the Application Function and handshake with the Application Function and establish the secure communication link using the session key, thereby securing the interface between the Application Function and the Authentication Function.

### BRIEF DESCRIPTION OF THE DRAWINGS

FIG. 1 is a schematic illustration of General Bootstrapping Architecture (GBA) according to the prior art.

FIG. 2 is a schematic illustration of a modified GBA according to the prior art.

FIG. 3 is a schematic illustration of GBA according to an embodiment.

FIG. 4 is a diagram illustrating message exchanges according to an embodiment.

FIG. 5 is a flowchart of a method executable by an Application Function according to an embodiment.

FIG. 6 is a flowchart of a method executable by an Authentication Function according to an embodiment.

FIGS. 7 and 9 illustrate Application Function nodes according to some embodiments.

FIGS. 8 and 10 illustrate Authentication Function nodes according to some embodiments.

FIGS. 11-12 are schematic illustrations of a cloud environment in which embodiments can be deployed.

FIGS. 13 and 14 are flowcharts of methods according to some embodiments.

FIG. 15 is a schematic illustration of an example according to an embodiment.

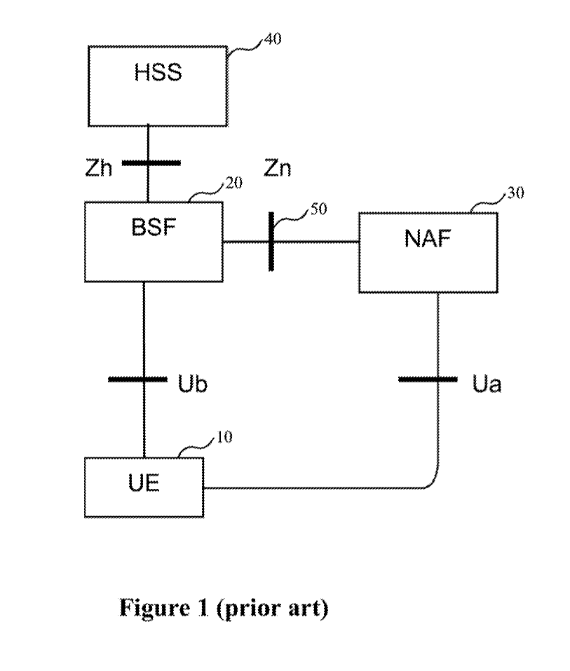

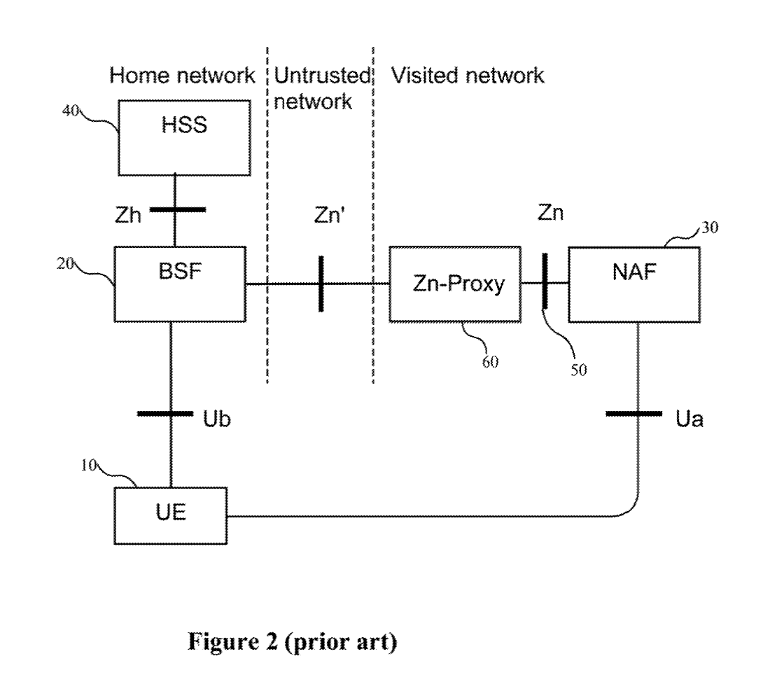

### DETAILED DESCRIPTION

Various features and embodiments will now be described with reference to the figures to fully convey the scope of the disclosure to those skilled in the art.

Many aspects will be described in terms of sequences of actions or functions. It should be recognized that in some embodiments, some functions or actions could be performed by specialized circuits, by program instructions being executed by one or more processors, or by a combination of both.

Further, some embodiments can be partially or completely embodied in the form of computer-readable carrier or carrier wave containing an appropriate set of computer instructions that would cause processing circuit to carry out the techniques described herein.

In some alternate embodiments, the functions/actions may occur out of the order noted in the sequence of actions. Furthermore, in some illustrations, some blocks, functions or actions may be optional and may or may not be executed.

In current General Bootstrapping Architecture (GBA), for cases where the Network Application Function (NAF) is not located in a secure zone, also called militarized zone, with the Bootstrapping Server Function (BSF), Transport Layer Security (TLS) is defined as a secure method of transport for the Zn interface, which is also called the Zn reference point. This TLS connection on the Zn interface can currently be accomplished only with the use of asymmetric encryption through the installation and use of certificates, i.e. private and public keys in the Application Function, e.g. the NAF, and in the Authentication Function, e.g. the BSF, respectively.

In asymmetric encryption, a key pair is used. A public key is made public and available to other entities. A second, private key is kept secret. Any message that is encrypted by using a public key can only be decrypted by applying the same algorithm with the corresponding private key. Conversely, a message that is encrypted by using the private key can only be decrypted by using the corresponding public key.

Asymmetric encryption has several disadvantages, especially in the context of the Internet of Things (IoT). First, it is slower than symmetric encryption (which will be described further below). Asymmetric encryption requires more processing power to both encrypt and decrypt the content of the message.

Second, using asymmetric encryption is limiting in the sense that Public Key Infrastructure (PKI) systems and certificates have to be used. Using PKI and certificates requires that a Certificate Authority validate the certificates. In the case of IoT, where there will be millions and eventually billions of connected devices, the certificate solution will suffer from scaling problems when a large amount of communication links has to be secured using TLS.

Symmetric encryption is therefore a more flexible and expandable solution for establishing Transport Layer Security (TLS). Symmetric encryption is based on a shared secret, i.e. a secret key, which can be a number, a word, or just a string of random letters that is shared and applied on both ends to encrypt and decrypt messages.

Embodiments described herein provide a solution for provisioning network nodes with a shared secret in a secure manner and for establishing a secure communication link on an interface between two network nodes using the shared secret.

In one embodiment, a method is defined for an Application Function, e.g. a NAF, located in an unsecure zone, to perform a bootstrapping procedure with an Authentication Function, e.g. a BSF. This method is proposed as a way to secure a new interface, called Znb, between the NAF and BSF. Once the bootstrapping is accomplished, the NAF and BSF have a pre-shared key (PSK) which can be used to perform a TLS-PSK cipher, thus creating a secure channel, without the need of public/private certificates. Further, TLS-PSK is based on time-limited session keys from the GBA bootstrapping method and is more secured than TLS-PKI (which is based on certificates).

In order to overcome some of the described problems, in the embodiments described below, the Application function, e.g. the NAF, may be provisioned with a

Subscriber Identity Module (SIM) or alternatively with software SIM credentials (which is the software equivalent to the physical SIM). These credentials can be used during the bootstrapping to generate a GBA session key. The GBA session key can then be used by the NAF to create a TLS-PSK tunnel with the Authentication Function, e.g. the BSF.

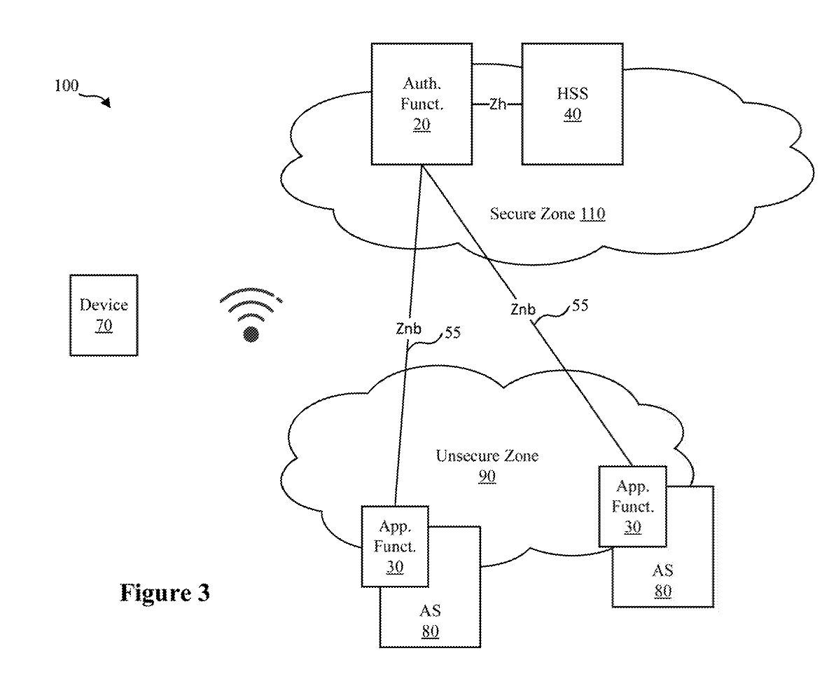

FIG. 3 illustrates a system 100 comprising a Device 70, which can be a User Equipment (UE), a Machine-to-Machine (M2M) device, any type of connected computing device or any type of sensor device that needs to transmit and/or receive data. The system 100 comprises a secure zone 110, also called militarized zone, in which the Authentication Function 20 and the HSS 40 are located. The Authentication Function 20 and the HSS 40 can typically communicate securely in the secure zone. It should be noted, however, that in some embodiments, the Authentication Function 20 and the HSS 40 could, either or both, be located outside the secure zone 110, e.g. in the cloud. For example, these nodes 20, 40 could run in a data center providing a pool of configurable computer resources. In such a case, a method similar to the one presented herein could be used for securing the communication between these nodes. The system 100 also comprises an unsecure zone 90, in which the Application Function 30 and the Application Server 80 are located, and in which they can communicate with each other. Theses nodes are typically, but not necessarily, owned by the same entity. The system 100 includes the new Znb interface 55, which will be details further below.

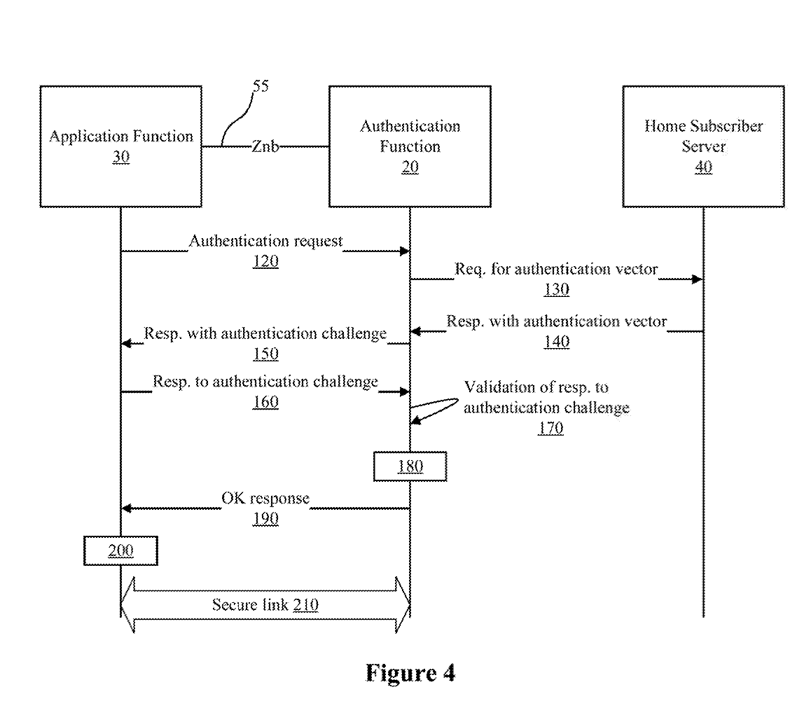

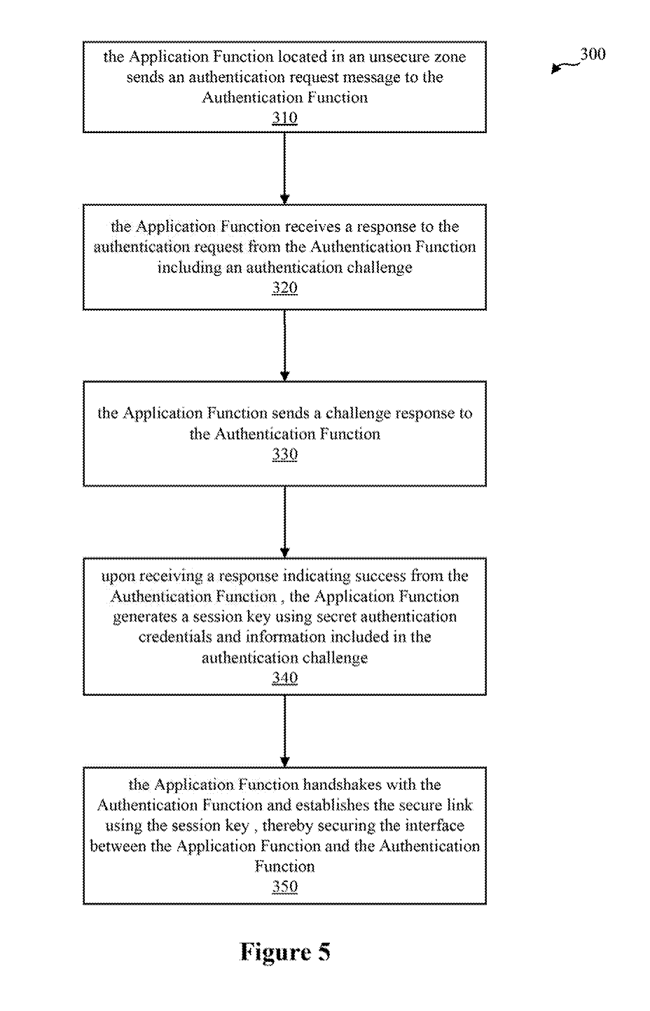

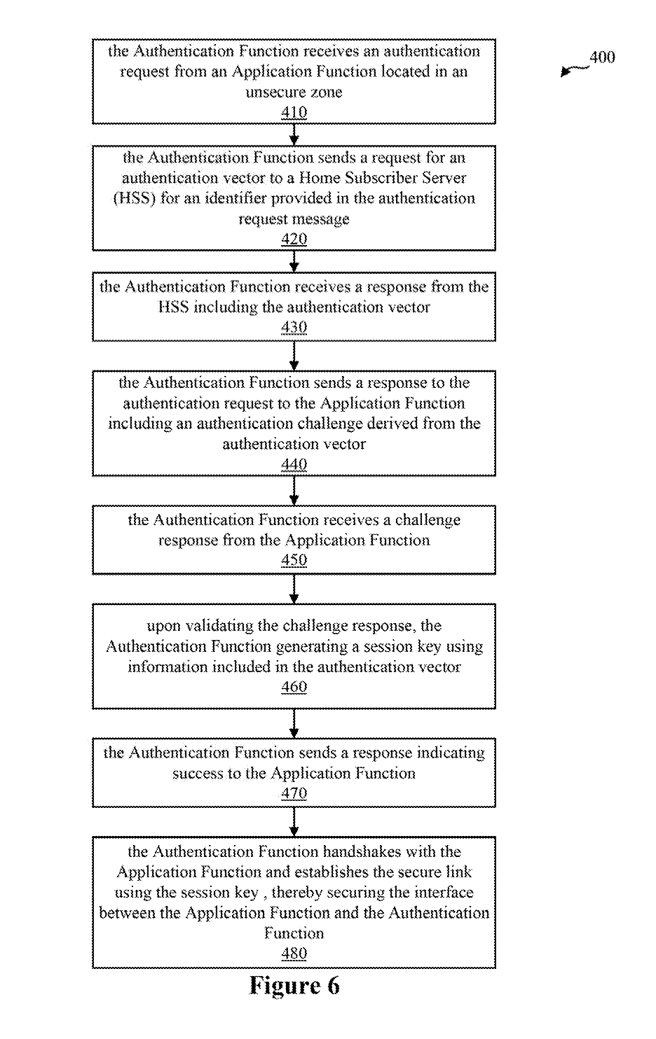

FIG. 4 illustrates messages exchanged between the Application Function 30, located in an unsecure zone, the Authentication Function 20 and the HSS 40. The messages exchanged between these nodes will be further described in relation to the methods of FIGS. 5 and 6.

FIG. 5 illustrates a method 300 for securing an interface and for securing a process for establishing a secure communication link between an Application Function 30 located in an unsecure zone and an Authentication Function 20. The method 300 comprises step 310 in which the Application Function 30 sends an authentication request message 120 to the Authentication Function 20. The method 300 comprises step 320 in which the Application Function 30 receives a response to the authentication request 150 from the Authentication Function including an authentication challenge. The method 300 comprises step 330 in which the Application Function 30 sends a challenge response 160 to the Authentication Function 20. The method 300 comprises step 340 in which, upon receiving a response indicating success 190 from the Authentication Function 20, the Application Function 30 generates a session key 200 using secret authentication credentials and information included in the authentication challenge (not illustrated). The method 300 comprises step 350 in which the Application Function 30 handshakes with the Authentication Function 20 and establishes the secure communication link 210 using the session key 200, thereby securing the interface 55 between the Application Function 30 and the Authentication Function 20.

As explained above, the Application Function may be a Network Application Function (NAF) 30 and the Authentication Function may be a Bootstrapping Server Functionality (BSF) 20 as defined in Generic Bootstrapping Architecture (GBA).

The interface 55 may be called a Znb interface or reference point between the NAF 30 and the BSF 20. However the actual “Znb” name could differ, as long as the method for securing the interface and for securing the process for establishing the secure communication link is the same.

In the method 300, the authentication challenge may be an authentication vector generated by a Home Subscriber Server (HSS) 40 and the session keys may be Bootstrapping Key Session (Ksb) useable for a specific Application Function 30. This means that the Ksb can be used for securing a link between the Authentication Function 20 and only one Application Function 30. The information included in the authentication challenge can include a Message Authentication Code (MAC) and Random number (RAND), for example.

The secret authentication credentials that are stored in the Application Function 30 may comprise a physical Subscriber Identity Module (SIM), an embedded SIM or a software SIM. A person skilled in the art would know that other variations of hardware or software authentication credentials, having security levels similar to that of a SIM card, could also be used interchangeably.

In the method 300, the secure communication link may be a Transport Layer Security based on Pre-Shared Key ciphersuite (TLS-PSK) tunnel.

FIG. 6 illustrates a method 400 for securing an interface and for securing a process for establishing a secure communication link between an Application Function 30 located in an unsecure zone and an Authentication Function 20. The method 400 comprises step 410 in which the Authentication Function 20 receives an authentication request message 120 from the Application Function 30. The method 400 comprises step 420 in which the Authentication Function 20 sends a request for an authentication vector 130 to a Home Subscriber Server (HSS) 40 for an identifier provided in the authentication request message 120. The method 400 comprises step 430 in which the Authentication Function 20 receives a response 140 from the HSS 40 including the authentication vector. The method 400 comprises step 440 in which the Authentication Function 20 sends a response to the authentication request 150 to the Application Function 30 including an authentication challenge derived from the authentication vector. The method 400 comprises step 450 in which the Authentication Function 20 receives a challenge response 160 from the Application Function 30. The method 400 comprises step 460 in which upon validating the challenge response 170, the Authentication Function 20 generates a session key 180 using information included in the authentication vector. The method 400 comprises step 470 in which the Authentication Function 20 sends a response indicating success 190 to the Application Function 30. The method 400 comprises step 480 in which the Authentication Function 20 handshakes with the Application Function 30 and establishes the secure communication link 210 using the session key 180, thereby securing the interface between the Application Function 30 and the Authentication Function 20.

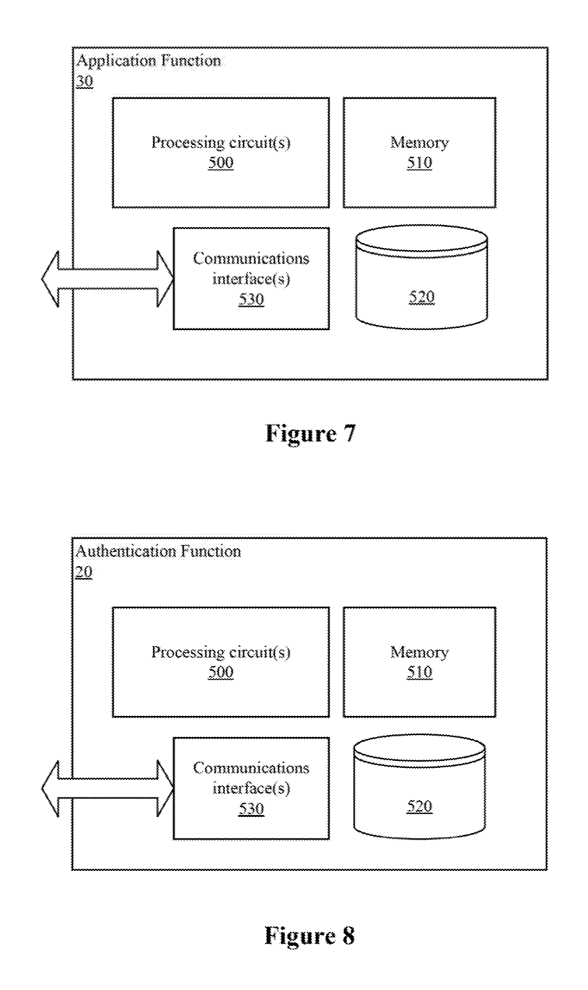

FIG. 7 illustrates an Application Function 30 node located in an unsecure zone for securing an interface and a process for establishing a secure communication link towards an Authentication Function 20, as described previously. The Application Function node 30 comprises a processor or processing circuit 500 and a memory 510, 520, the memory 510 is a transitory memory and the memory 520 is a non-transitory memory, the memory 510, 520 contains instructions executable by the processing circuit 500 whereby the Application Function 30 node is operative to execute a method 300 as described previously in relation to FIG. 5. The Application Function 30 node further comprises at least one communications interface 530 to be able to communicate with a network or with other nodes as would be apparent to a person skilled in the art.

FIG. 8 illustrates an Authentication Function node 20 for securing an interface and a process for establishing a secure communication link towards an Application Function 30 located in an unsecure zone, as described previously. The Authentication function 20 node comprises a processor or processing circuit 500 and a memory 510, 520, the memory 510 is a transitory memory and the memory 520 is a non-transitory memory, the memory 510, 520 containing instructions executable by the processing circuit 500 whereby the Authentication Function 20 node is operative to execute a method 400 as described previously in relation to FIG. 6. The Authentication Function node 20 further comprises at least one communications interface 530 to be able to communicate with a network or with other nodes as would be apparent to a person skilled in the art.

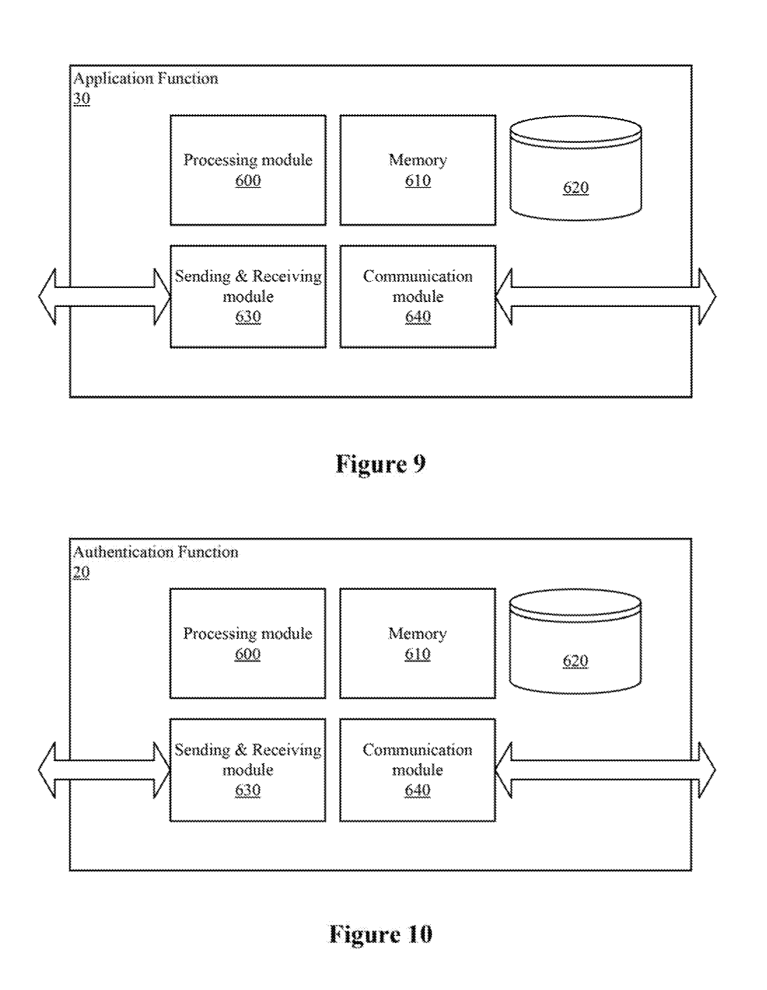

FIG. 9 illustrates an Application Function node 30 located in an unsecure zone for securing an interface and a process for establishing a secure communication link towards an Authentication Function 20. The Application Function node 30 comprises a sending module 630 for sending an authentication request message 120 to the Authentication Function 20. The Application Function node 30 comprises a receiving module 630 for receiving a response to the authentication request 150 from the Authentication Function 20 including an authentication challenge. The sending and the receiving modules 630 could alternatively be separate modules. The sending module 630 is further for sending a challenge response 160 to the Authentication Function 20. The receiving module 630 is further for receiving a response indicating success 190 from the Authentication Function 20. The Application Function node 30 comprises a processing module 600 for generating a session key using secret authentication credentials and information included in the authentication challenge, upon receiving the response indicating success 190. The Application Function node 30 comprises a communication module 640 for handshaking with the Authentication Function 20 and establishing the secure communication link 210 using the session key, thereby securing the interface between the Application Function node 30 and the Authentication Function 20. The Application Function node 30 also comprises at least one memory module 610, 620, the memory module 610 is a transitory memory and the memory 620 is a non-transitory memory, the memory module 610, 620 containing instructions executable by the processing module. The Application Function node 30 is operative to execute a method 300 as described previously in relation to FIG. 5.

FIG. 10 illustrates an Authentication Function node 20 for securing an interface and a process for establishing a secure communication link towards an Application Function 30 located in an unsecure zone. The Authentication Function node 20 comprises a receiving module 630 for receiving an authentication request message 120 from the Application Function. The Authentication Function node 20 comprises a sending module 630 for sending a request for an authentication vector 130 to a Home Subscriber Server (HSS) 40 for an identifier provided in the authentication request message 120. The sending and the receiving modules 630 could alternatively be separate modules. The receiving module 630 is further for receiving a response 140 from the HSS including the authentication vector. The sending module 630 is further for sending a response 150 to the authentication request to the Application Function 30 including an authentication challenge derived from the authentication vector. The receiving module 630 is further for receiving a challenge response 160 from the Application Function 30. The Authentication Function node 20 comprises a processing module 600 for generating a session key 180 using information included in the authentication vector, upon validating 170 the challenge response. The sending module 630 is further for sending a response indicating success 190 to the Application Function 30. The Authentication Function node 20 comprises a communication module 640 for handshaking with the Application Function 30 and establishing the secure communication link 210 using the session key, thereby securing the interface between the Application Function 30 and the Authentication Function node 20. The Authentication Function node 20 also comprises at least one memory module 610, 620, the memory module 610 is a transitory memory and the memory 620 is a non-transitory memory, the memory module 610, 620 containing instructions executable by the processing module. The Authentication Function node 20 is operative to execute a method 400 as described previously in relation to FIG. 6.

Although all of the details of the Application Function node 30 and Authentication Function node 20 of FIGS. 7 to 10 are not illustrated, these nodes 20, 30 comprise one or several general-purpose or special-purpose processors 500, 600 or other microcontrollers programmed with suitable software programming instructions and/or firmware to carry out some or all of the functionality of the nodes 20, 30 described herein. In addition, or alternatively, the nodes 20, 30 may comprise various digital hardware blocks (e.g., one or more Application Specific Integrated Circuits (ASICs), one or more off-the-shelf digital or analog hardware components, or a combination thereof) (not illustrated) configured to carry out some or all of the functionality of the controller nodes 20, 30 described herein. A memory 510, 610, such as a random access memory (RAM), may be used by the processor, or processing circuit, 500, 600 to store data and programming instructions which, when executed by the processor 500, 600, implement all or part of the functionality described herein. The nodes 20, 30 may also include one or more storage media 520, 620 for storing data necessary and/or suitable for implementing the functionality described herein, as well as for storing the programming instructions which, when executed on the processor 500, 600, implement all or part of the functionality described herein. One embodiment of the present disclosure may be implemented as a computer program product that is stored on a computer-readable storage medium, the computer program product including programming instructions that are configured to cause the processor 500, 600 to carry out the steps described herein.

Referring back to FIGS. 7 and 9, there are provided a non-transitory computer media 520, 620 having stored thereon instructions for securing an interface and for securing a process for establishing a secure communication link between an Application Function 30 and an Authentication Function 20. The instructions comprise steps of a method 300 as previously described in relation to FIG. 5.

Referring back to FIGS. 8 and 10, there are provided non-transitory computer media 520, 620 having stored thereon instructions for securing an interface and for securing a process for establishing a secure communication link between an Application Function 30 and an Authentication Function 20. The instructions comprise steps of a method 400 as previously described in relation to FIG. 6.

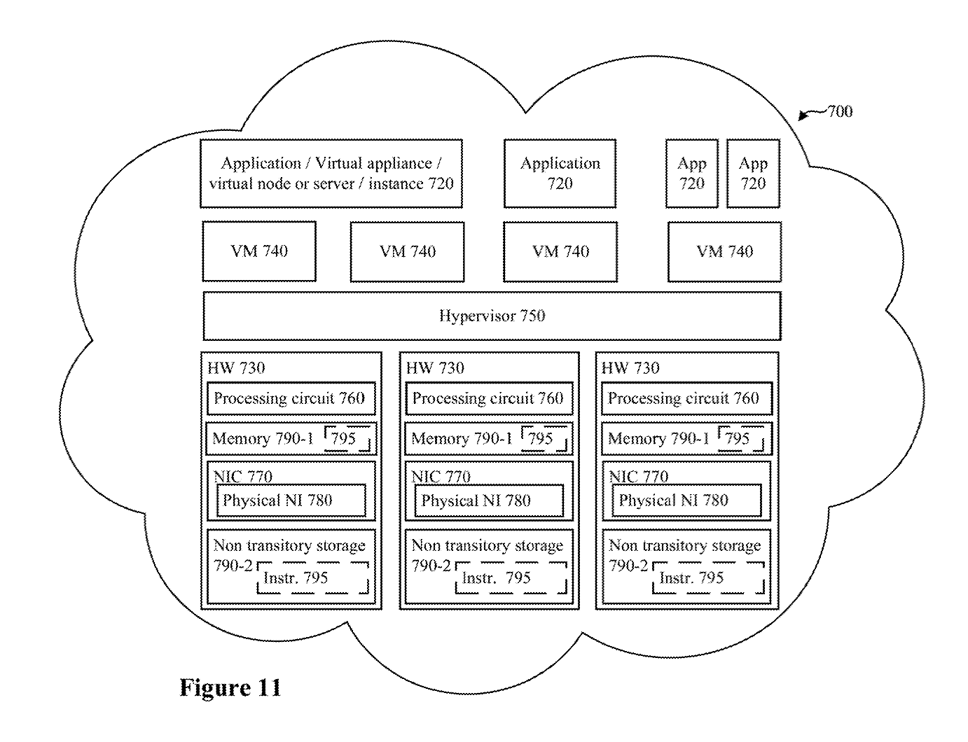

Referring to FIG. 11, there is provided an Application Function instance 720, located in an unsecure zone in a cloud computing environment 700 which provides processing circuit 760 and memory 790 for running the Application Function instance 720. The memory 790 contains instructions 795 executable by said processing circuit 760 whereby the Application Function instance 720 is operative to execute the method 300 as previously described in relation to FIG. 5.

The cloud computing environment 700, comprises a general-purpose network device including hardware 730 comprising a set of one or more processor(s) or processing circuit 760, which can be commercial off-the-shelf (COTS) processors, dedicated Application Specific Integrated Circuits (ASICs), or any other type of processing circuit including digital or analog hardware components or special purpose processors, and network interface controller(s) 770 (NICs), also known as network interface cards, which include physical Network Interface 780. The general-purpose network device also includes non-transitory machine readable storage media 790-2 having stored therein software 795 and/or instructions executable by the processor 760. During operation, the processor(s) 760 execute the software 795 to instantiate a hypervisor 750, sometimes referred to as a virtual machine monitor (VMM), and one or more virtual machines 740 that are run by the hypervisor 750. A virtual machine 740 is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes. Each of the virtual machines 740, and that part of the hardware 730 that executes that virtual machine, be it hardware dedicated to that virtual machine and/or time slices of hardware temporally shared by that virtual machine with others of the virtual machine(s) 740, forms a separate virtual network element(s) (VNE).

The hypervisor 750 may present a virtual operating platform that appears like networking hardware to virtual machine 740, and the virtual machine 740 may be used to implement functionality such as control communication and configuration module(s) and forwarding table(s), this virtualization of the hardware is sometimes referred to as network function virtualization (NFV). Thus, NFV may be used to consolidate many network equipment types onto industry standard high volume server hardware, physical switches, and physical storage, which can be located in Data centers, and customer premise equipment (CPE). Different embodiments of the Application Function 30 and Authentication Function 20 instances may be implemented on one or more of the virtual machine(s) 740, and the implementations may be made differently.

Still referring to FIG. 11, there is provided an Authentication Function instance 720, in a cloud computing environment 700 which provides processing circuit 760 and memory 790 for running the Authentication Function instance 720. The memory 790 contains instructions 795 executable by the processing circuit 760 whereby the Authentication Function instance 720 is operative to execute the method 400 as previously described in relation to FIG. 6.

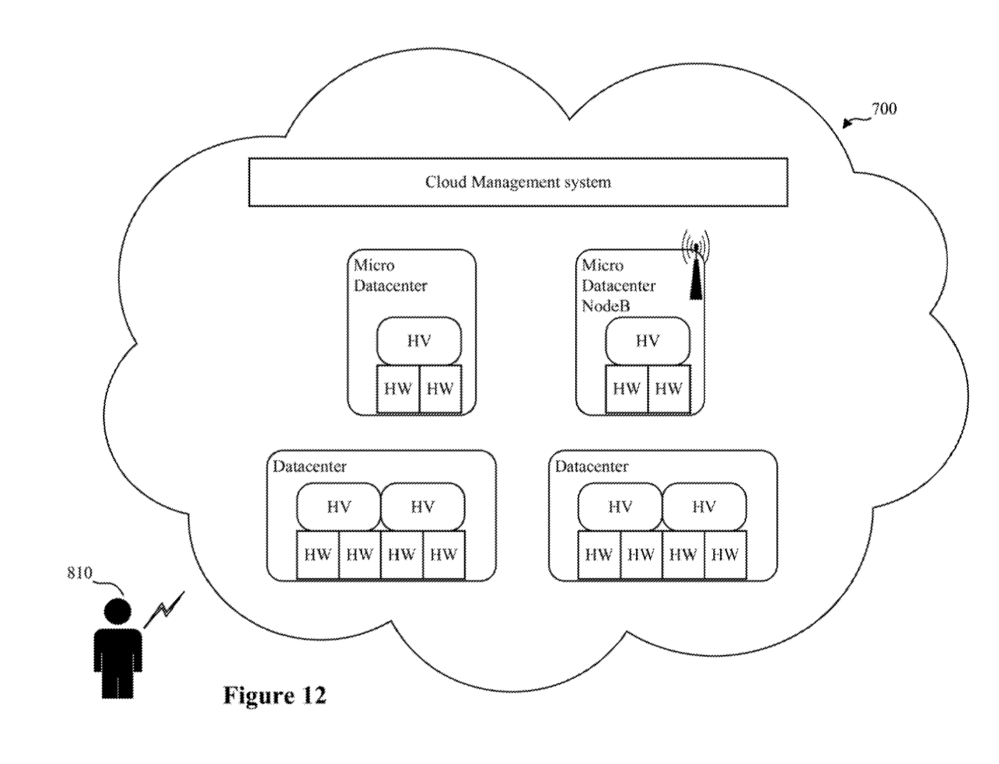

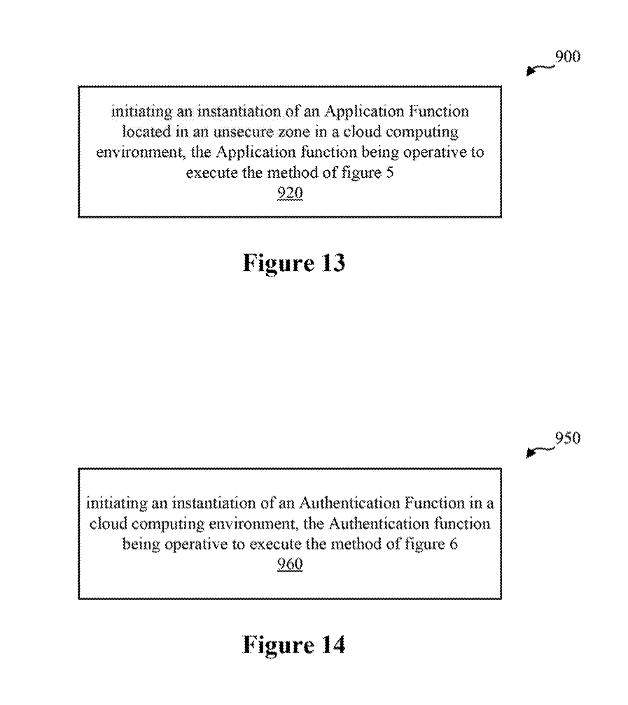

Referring to FIGS. 12 and 13 there is provided a method 900 comprising the step 920 of initiating, by a user 810, an instantiation of an Application Function located in an unsecure zone in a cloud computing environment 800 which provides processing circuit and memory for running the Application Function, the Application function being operative to execute the method 300 as previously described in relation to FIG. 5.

Still referring to FIG. 12 and referring to FIG. 14, there is provided a method 950 comprising the step 960 of initiating, by a user 810, an instantiation of an Authentication Function in a cloud computing environment 800 which provides processing circuit and memory for running the Authentication Function, the

Authentication function being operative to execute the method 400 as previously described in relation to FIG. 6.

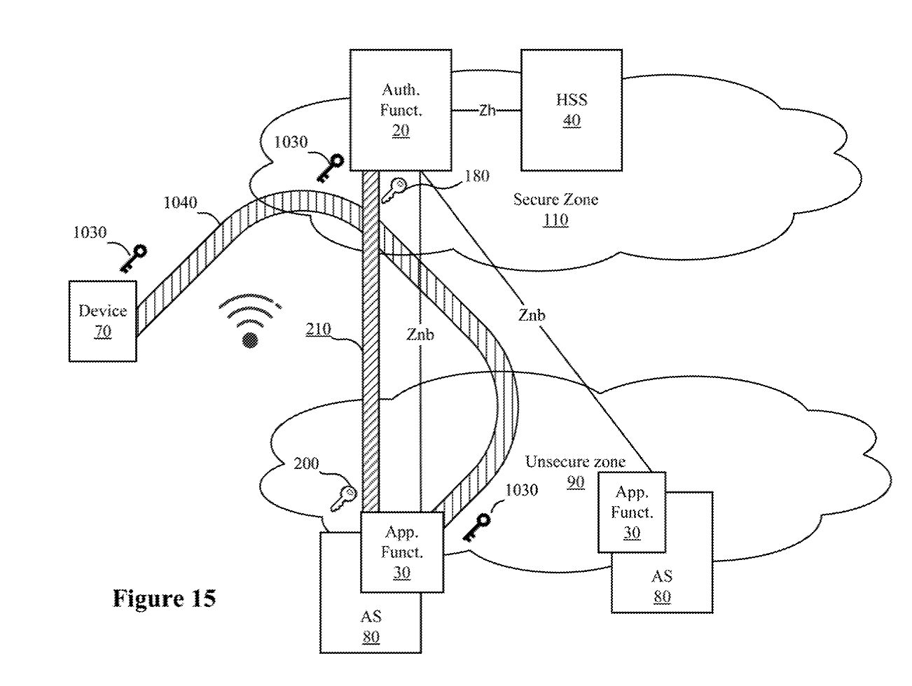

FIG. 15 illustrates an example embodiment comprising a device 70, which can be, but is not limited to, a standalone device such as a sensor, a smart meter, a connected car, a medical device, a user equipment, a watch, a headset, glasses, a home appliance, etc. The device 70 may also be a plurality of devices, such as, but not limited to, an electrical grid, a network of connected devices, such as sensors, cameras, microphones, computing devices, cars, trucks, bus, trains, planes, bicycles, vending machines, industrial machinery, public utilities, smart buildings, meters, fixtures (light, heat, cooling), advertisement displays, etc.

The HSS 40 is provisioned with secret authentication credentials pertaining to each Application Function 30 located in an unsecure zone. The same authentication credentials are also provisioned in the Application Functions 30. This step can be done offline (e.g. by inserting a physical SIM) or online (by provisioning the Application Function 30 with a software SIM, for example, as explained previously). This step has to be done in a secure manner, as would be apparent to a person skilled in the art.

When an Application Function 30 is ready to authenticate with the Authentication Function 20, it performs the self-bootstrapping method 300, based on a shared secret, as explained previously in relation to FIG. 5. A key derivation procedure can be used by the Authentication Function 20 to generate the session keys 180, 200 for a specific Application Function 30. A secure TLS PSK communication tunnel 210 is then established between the Application function 30 and the Authentication function 20, using the session keys 180, 200.

Then, the device 70 and the Authentication Function 20 can mutually authenticate using the second generation (2G) Authentication and Key Agreement (AKA) protocol (as described in the standard document referred to in the background section), and agree on session keys 1030 that are afterwards applied between the device 70 and a specific Application Function 30. A TLS PSK communication tunnel 1040 can then also be established between the device 70 and the Application Function 30, using the session keys 1030.

After the bootstrapping has been completed, the device 70 and Application Function 30 can run some application-specific protocol where the authentication of messages are based on the session keys 1030 generated during the mutual authentication between device 70 and Application Function 30. The device 70, the Application Function 30 and the Application Server 80 can then communicate securely.

Modifications and other embodiments will come to mind to one skilled in the art having the benefit of the teachings presented in the foregoing description and the associated drawings. Therefore, it is to be understood that modifications and other embodiments, such as specific forms other than those of the embodiments described above, are intended to be included within the scope of this disclosure. The described embodiments are merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitations.

1. A method for securing an interface and for securing a process for establishing a secure communication link between an Application Function located in an unsecure zone and an Authentication Function, comprising:
the Application Function sending an authentication request message to the Authentication Function;
the Application Function receiving a response to the authentication request from the Authentication Function including an authentication challenge;
the Application Function sending a challenge response to the Authentication Function;
upon receiving a response indicating success from the Authentication Function, the Application Function generating a session key using secret authentication credentials and information included in the authentication challenge; and
the Application Function handshaking with the Authentication Function and establishing the secure communication link using the session key, thereby securing the interface between the Application Function and the Authentication Function.

2. The method of claim 1, wherein the Application Function is a Network Application Function (NAF) and the Authentication Function is a Bootstrapping Server Functionality (BSF) as defined in Generic Bootstrapping Architecture (GBA) and wherein the interface is an interface between the NAF and the BSF.

3. (canceled)

4. The method of claim 1, wherein the authentication challenge is an authentication vector generated by a Home Subscriber Server (HSS).

5. method of claim 1, wherein the session keys are Bootstrapping Key Session (Ksb) useable for a specific Application Function.

6. The method of claim 1, wherein the secret authentication credentials comprise a physical Subscriber Identity Module (SIM), an embedded SIM or a software SIM.

7. The method of claim 1, wherein the information included in the authentication challenge includes a Message Authentication Code (MAC) and Random number (RAND);

8. The method of claim 1, wherein the secure communication link is a Transport Layer Security based on Pre-Shared Key ciphersuite (TLS-PSK) tunnel.

9. A method for securing an interface and for securing a process for establishing a secure communication link between an Application Function located in an unsecure zone and an Authentication Function, comprising:
the Authentication Function receiving an authentication request message from the Application Function;
the Authentication Function sending a request for an authentication vector to a Home Subscriber Server (HSS) for an identifier provided in the authentication request message;
the Authentication Function receiving a response from the HSS including the authentication vector;
the Authentication Function sending a response to the authentication request to the Application Function including an authentication challenge derived from the authentication vector;
the Authentication Function receiving a challenge response from the Application Function;
upon validating the challenge response, the Authentication Function generating a session key using information included in the authentication vector;
the Authentication Function sending a response indicating success to the Application Function; and
the Authentication Function handshaking with the Application Function and establishing the secure communication link using the session key, thereby securing the interface between the Application Function and the Authentication Function.

10. The method of claim 9, wherein the Application Function is a Network Application Function (NAF) and the Authentication Function is a Bootstrapping Server Functionality (BSF) as defined in Generic Bootstrapping Architecture (GBA) and wherein the interface is an interface between the NAF and the BSF.

11. (canceled)

12. The method of claim 9, wherein the session keys are Bootstrapping Key Session (Ksb) useable for a specific Application Function.

13. The method of claim 9, wherein the information included in the authentication challenge includes a Message Authentication Code (MAC) and Random number (RAND);

14. The method of claim 9, wherein the secure communication link is a Transport Layer Security based on Pre-Shared Key ciphersuite (TLS-PSK) tunnel.

15. An Application Function node located in an unsecure zone for securing an interface and a process for establishing a secure communication link towards an Authentication Function, the Application Function node comprising a processing circuit and a memory, said memory containing instructions executable by said processing circuit whereby said Application Function node is operative to:
send an authentication request message to the Authentication Function;
receive a response to the authentication request from the Authentication Function including an authentication challenge;
send a challenge response to the Authentication Function;
upon receiving a response indicating success from the Authentication Function, generate a session key using secret authentication credentials and information included in the authentication challenge; and
handshake with the Authentication Function and establish the secure communication link using the session key, thereby securing the interface between the Application Function and the Authentication Function.

16. The Application Function node of claim 15, wherein the Application Function node is a Network Application Function (NAF) and the Authentication Function is a Bootstrapping Server Functionality (B SF) as defined in Generic Bootstrapping Architecture (GBA) and wherein the interface is an interface between the NAF and the BSF.

17. (canceled)

18. The Application Function node of claim 15, wherein the authentication challenge is an authentication vector generated by a Home Subscriber Server (HSS).

19. The Application Function node of claim 15, wherein the session keys are Bootstrapping Key Session (Ksb) useable for a specific Application Function.

20. The Application Function node of claim 15, wherein the secret authentication credentials comprise a physical Subscriber Identity Module (SIM), an embedded SIM or a software SIM.

21. The method of claim 15, wherein the information included in the authentication challenge includes a Message Authentication Code (MAC) and Random number (RAND);

22. The Application Function node of claim 15, wherein the secure communication link is a Transport Layer Security based on Pre-Shared Key ciphersuite (TLS-PSK) tunnel.

23. An Authentication Function node for securing an interface and a process for establishing a secure communication link towards an Application Function located in an unsecure zone, the Authentication function node comprising a processing circuit and a memory, said memory containing instructions executable by said processing circuit whereby said Authentication Function node is operative to:
receive an authentication request message from the Application Function;
send a request for an authentication vector to a Home Subscriber Server (HSS) for an identifier provided in the authentication request message;
receive a response from the HSS including the authentication vector;
send a response to the authentication request to the Application Function including an authentication challenge derived from the authentication vector;
receive a challenge response from the Application Function;
upon validating the challenge response, generate a session key using information included in the authentication vector;
send a response indicating success to the Application Function; and
handshake with the Application Function and establish the secure communication link using the session key, thereby securing the interface between the Application Function and the Authentication Function.

24. The Authentication Function node of claim 23, wherein the Application Function is a Network Application Function (NAF) and the Authentication Function node is a Bootstrapping Server Functionality (B SF) as defined in Generic Bootstrapping Architecture (GBA) and wherein the interface is an interface between the NAF and the BSF.

25. (canceled)

26. The Authentication Function node of claim 23, wherein the session keys are Bootstrapping Key Session (Ksb) useable for a specific Application Function.

27. The method of claim 23, wherein the information included in the authentication challenge includes a Message Authentication Code (MAC) and Random number (RAND);

28. The Authentication Function node of claim 23, wherein the secure communication link is a Transport Layer Security based on Pre-Shared Key ciphersuite (TLS-PSK) tunnel.

29-60. (canceled)
